(19) United States
(12) Patent Application Publication
(10) Pub. No.: US 2010/0077955 A1
(43) Pub. Date: Apr. 1, 2010

(54) Cable identifier system

(76) Inventor: Vincent J. Lee, La Mirada, CA (US)

Correspondence Address: Edward E. Roberts, P.O. Box 3206, Dana Point, CA, 92629, US

(21) Appl. No.: 12/284,837

(22) Filed: Sep. 26, 2008

(51) Int. Cl. G01D 13/08

(52) U.S. Cl. 116/284

(57) ABSTRACT

A cable identifier system including an attachment plug at each end of the cable configured to provide cable tracking capabilities. The attachment plug is configured to include a rotatable device which is rotated through a series of numbers or letters until a desired alphanumeric symbol is designated.

### BACKGROUND

The background of the invention will be discussed in two parts.

1. Field of the Invention

The invention relates to audio-visual cables, and more particularly, to a system providing for tracking of a plurality of audio-visual cables.

2. Description of the Prior Art

There is a considerable number of audio-visual cables cable to be found in the marketplace, each generally optimized for a particular usage with a particular set of characteristics. However, there has been a continuing need for a simple, effective way to track a plurality of audio-visual cables to thus identify specific inputs. A search of the prior art has not disclosed such a tracking system or method. It is thus an aspect of the present invention to provide an audio-visual cable and method of use that provides such a tracking/identifier system.

### SUMMARY

In accordance with the invention, an exemplary component such as a hand-held microphone is disclosed having a cable connected attachment plug configured to provide cable tracking capabilities. The attachment plug is configured to include a rotatable device which can turned through a series of numbers or letters until a desired alphanumeric symbol is designated. An identically configured attachment plug is provided at the other end of the cable which is plugged into a multiple input/output extension box having the same desired alphanumeric symbol.

### DRAWINGS

FIG. 1 is a perspective view illustrating the cable tracking/identifier system in accordance with the invention;

FIG. 2 illustrates the attachment plug of the invention as attached to the exemplary hand-held microphone;

FIG. 3 is an exploded view of the attachment plug of an unmodified exemplary microphone;

FIG. 4 is an exploded view of the attachment plug in accordance with the invention;

FIG. 5 is a cross-sectional view of the attachment plug of the invention taken along lines 5-5 of FIG. 2;

FIG. 6 is an exploded view of an alternate embodiment of the attachment plug in accordance with the invention;

FIG. 7 illustrates the alternate embodiment of the attachment plug as assembled and as operated;

FIG. 8 FIG. 3 is a cross-sectional view of the alternate embodiment of the attachment plug as taken along lines 8-8 of FIG. 7; and

FIG. 9 is a perspective view of an array of exemplary microphones illustrating the cable tracking system.

### DESCRIPTION

Referring now to the drawings, in which like reference numerals refer to like elements in the several views, there is illustrated a first embodiment of the tracking system of the invention.

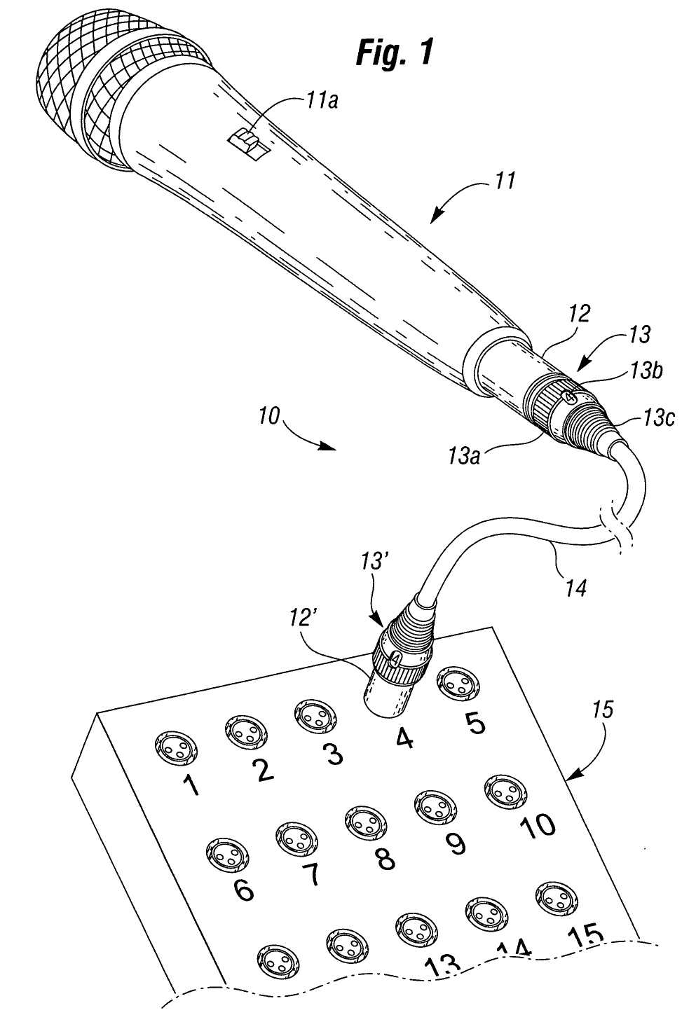

FIG. 1 is a perspective view illustrating the cable identifier system of the invention, generally designated 10, which includes the exemplary hand-held microphone 11 with switch 11a, female plug body 12, attachment plug, generally designated 13, cable or cord 14, second attachment plug 13′, male plug body 12′, and multiple input/output extension box, generally designated 15. Plug bodies 12 and 12′ are identical except that plug body 12 is configured as a female plug whereas plug body 12′ is configured as a male plug. Attachment plug bodies 13 and 13′ are identical. Thus, only female plug body 12 and attachment plug 13 will be described.

Plug body 12 terminates with a female socket configured to accept matching male plugs in the exemplary microphone 11. Plug body 12 would similarly be connected to components that may be used in the system other than microphone 11, such as a guitar or keyboard. Conductors in cord 14 are soldered to the female socket connectors. Attachment plug 13 is attached to plug 12 as will be described. Attachment plug 13 is shown with securing nut 13a having window 13b through which the selected number “4” can be seen, and with rotatable flexible grommet 13c. The selected numbers are numeric band 40a of compression ring 40 as shown in FIG. 4. Multiple input/output extension box 15 is shown with male plug body 12′ mated with a female receptacle also designated by the numeral “4”. Multiple female receptacles having differently designated numbers are available for receiving other plug bodies in accordance with the invention. It is understood that instead of numbers the system of the invention could use alphabet letters or other symbols.

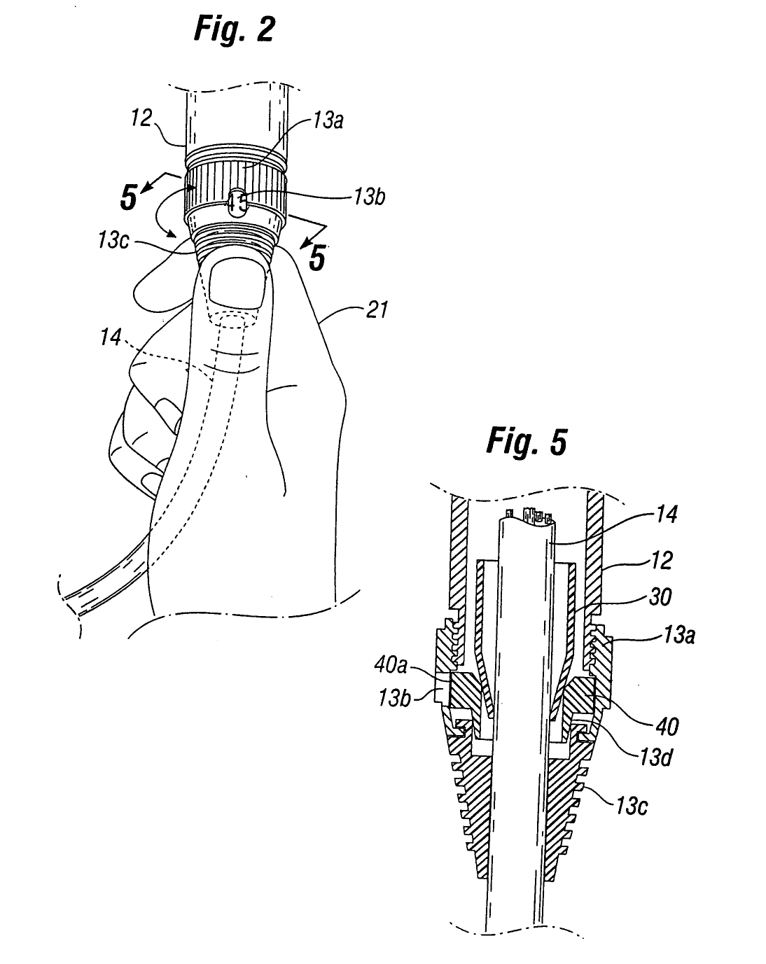

FIG. 2 illustrates the modified attachment plug 13 of the invention as attached to the exemplary microphone 11, and the method of operation of the indicia marking identifier. In operation, securing nut 13a can be rotated by the user which loosens the securing nut 13a sufficiently to allow rotation of the flexible finger grommet 13c to select the desired alphanumeric indicia that can be seen through window 13b. Flexible grommet 13c is in frictional contact with numeric band 40a (see FIG. 4) such that band 40a rotates simultaneously with grommet 13c. The securing nut 13a is then rotated by the user to retighten the securing nut 13a and thus maintain the selected alphanumeric indicia.

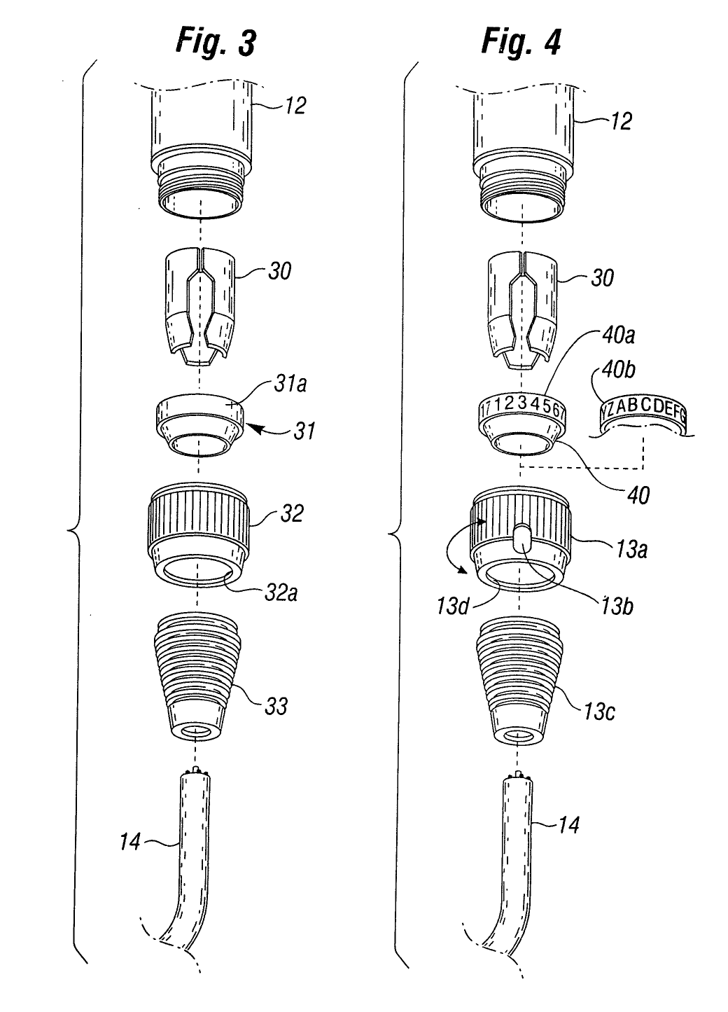

FIG. 3 illustrates in exploded view an exemplary microphone having a conventional plug body 12, cord lock sleeve 30, compression ring 31 having band 3 la, securing nut 32 having slip lock 32a, flexible grommet 33 and cord 14. As indicated, cord 14 is inserted in succession through grommet 33, securing nut 32, compression ring 31, cord lock sleeve 30, and then into female plug body 12. In plug body 12 the conductors of cord 14 are soldered onto pins in the female connector terminals of plug body 12 for plug-in connection with the microphone or other system component, such as a guitar or keyboard. Cord sleeve 30 is inserted into plug body 12 of microphone 11 and then tightened around cord 14 by compression ring 31 in response to securing nut 32 beings threaded onto plug body 12 and applying pressure to compression ring 31. Flexible grommet 33 is then attached by slip lock 32a to securing nut 32.

FIG. 4 illustrates in exploded view the present invention including conventional plug body 12, cord lock sleeve 30, compression ring 40 having numeric band 40a, securing nut 13a having window 13b and slip lock 13d, flexible grommet 41, and cord 14. As indicated, the compression ring 31 of FIG. 3, having band 31a, has been replaced with compression ring 40 having numeric band 40a with indicia thereon as has been explained, securing nut 32 of FIG. 3 has been replaced with securing nut 13a having window 13b and slip lock 13d, and grommet 33 of FIG. 3 has been replaced by grommet 41.

As further indicated in FIG. 4, cord 14 is inserted in succession through grommet 41, securing nut 13a, compression ring 40, cord sleeve 30, and into plug body 12. Cord 14 is then electrically connected within microphone 11 as previously described. Cord sleeve 30 is inserted into plug body 12 of microphone 11 and then tightened around cord 14 by compression ring 40 in response to securing nut 13a beings threaded onto plug body 12 and applying pressure to compression ring 40. Flexible grommet 41 is then attached by slip lock 13c to securing nut 13a.

FIG. 5 is a cross-sectional view of the invention taken along lines 5-5 of FIG. 2 illustrating the assembly of the components of the invention. As previously discussed, in operation securing nut 13a is rotated sufficiently to allow rotation of the flexible grommet to select the desired alphanumeric indicia that can be seen through window 13b. Flexible grommet 13c is assembled to be in sufficient frictional contact with truncated cone-shaped compression ring 40 (see FIG. 4) to provide that rotation of grommet 13c likewise rotates compression ring 40 and thus numeric band 40a. Band 40b illustrates that alphabet letters may be used as well as numeric indicia. The securing nut 13a is then manually rotated by the finger 21 of the user to retighten the securing nut 13a.

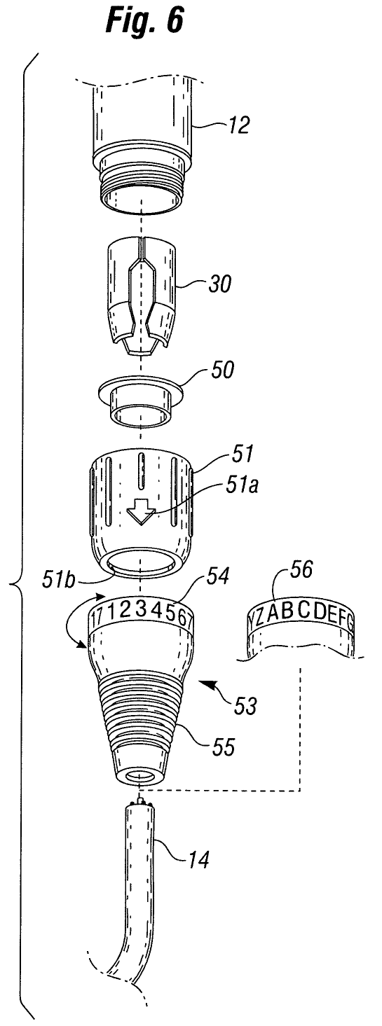

FIG. 6 illustrates in exploded view an alternate embodiment in accordance with the invention. As shown, the embodiment includes the plug body 12, cord lock sleeve 30 compression ring 50, nut 51 having arrow/pointer 51a and slip lock 51b, and one-piece identifier 53 having numeric band 54 and grommet 55. In assembly, cord 14 is inserted in succession through one-piece identifier 53, nut 51, compression ring 50 and cord sleeve 30, and then into plug body 12. As previously described, the conductors of cord 14 are then soldered onto pins in the female connector terminals of plug body 12 for connection with the microphone or other system component, such as a guitar or keyboard. Cord sleeve 30 is then inserted into plug body 12 and then tightened around cord 14 by compression ring 50 in response to pressure from nut 51 which is threaded into plug body 12. The flexible grommet 55 of one-piece rotatable identifier 53 is then positioned in frictional abutment with compression ring 50 and nut 51, to thus become a single unit attached to plug body 12. In operation the grommet 55 is manually rotated to thereby rotate the attached numeric band 54 such that the arrow 51a points to the selected number thereby providing identification of the associated cord. Band 56 illustrates that alphabet letters may be used as well as numeric indicia.

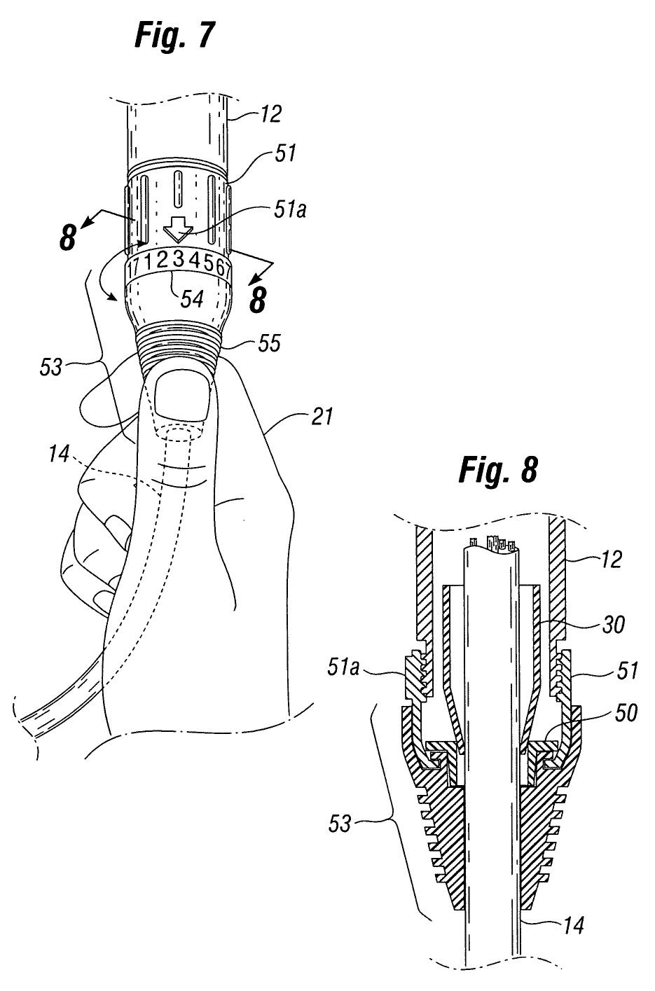

FIG. 7 illustrates the assembled alternate embodiment shown in FIG. 6. As described, grommet 55 can be manually rotated by the finger 21 of the user which rotates the numeric band 54 such that the arrow 51a designates a desired number.

FIG. 8 is a cross-sectional view taken along lines 8-8 of FIG. 7 illustrating the assembly of the components of the alternate embodiment of FIG. 6.

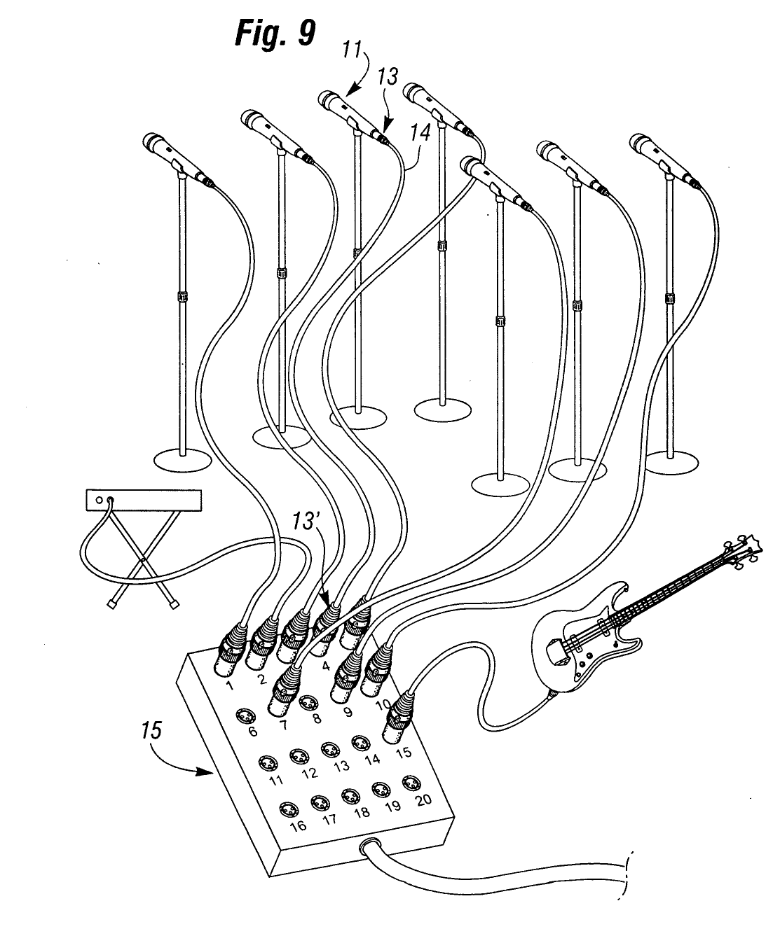

FIG. 9 is a perspective view illustrating the use of the invention in providing identification of a plurality of cords in an array of components such as microphones, guitars, keyboards, etc. Each component plug can have a different designated indicia that is matched by a multiple input/output extension box as indicated.

In accordance with the above, the invention has been shown and described with reference to specific illustrated embodiments. It is realized that those skilled in the art may make changes or modifications in the invention without departing from the true scope and spirit of it. Therefore, the scope and spirit of the invention should not be limited to the embodiments discussed, but only by the invention as claimed.

What is claimed is:

1. A cable identifier system comprising;
a conductive cable having on each end a plug body;
each said plug body coacting with means for setting of selected identifiable symbols, said means for setting of said symbols including
a rotary component having said symbols thereon;
means for rotating said rotary component for selection of a desired symbol; and
indicator means for viewing said selected symbol.

2. The cable identifier system of claim 1 wherein said means for setting of selected identifiable symbols comprises:
a lock sleeve for insertion into said plug body;
a compression ring for frictional engagement with said lock sleeve, said compression ring including a band having said symbols thereon;
a securing nut fitting over said compression ring and said lock sleeve to threadably mate with said plug body thereby forcing said compression ring onto said lock sleeve;
said indicator means includes a window in said securing nut for viewing said symbols when said securing nut is mated with said plug body;
a grommet;
said securing nut having a slip lock for accepting said grommet therethrough for frictional contact with said compression ring; and
whereby the rotation of said grommet rotates said compression ring to display said symbols through said window to enable selection of desired symbols.

3. The cable identifier system of claim 1 wherein said means for setting of selected identifiable symbols comprises:
a lock sleeve for insertion into said plug body;
a compression ring for frictional engagement with said lock sleeve;
a securing nut fitting over said compression ring and said lock sleeve to threadably mate with said plug body thereby forcing said compression ring onto said lock sleeve, said nut including a slip lock; and
a rotatable member having a band of symbols thereon, said member in frictional contact with said securing nut slip lock whereby the rotation of said member rotates said band of symbols for sequential display of said symbols; and
said rotatable member includes said indicator means for designation of desired symbols.

4. A cable identifier system for identifying a plurality of audio- visual input cables at a receiving station comprising;
a receiving station;
an array of sending components each connected to an associated cable, each cable having a first plug body connected to an associated sending component and a second identical plug body connected to said receiving station;
each said plug body coacting with means for setting of selected identifiable symbols, said means for setting of said symbols including a rotary component having said symbols thereon, means for rotating said rotary component for selection of a desired symbol and indicator means for viewing said selected symbol;
each sending component has its associated first and second plug bodies set to the same symbol with said second plug body mated to the same symbol at said receiving station; and
wherein each sending component has a different selected symbol.

5. The cable identifier system of claim 4 wherein said means for setting of selected identifiable symbols comprises:
a lock sleeve for insertion into said plug body;
a compression ring for frictional engagement with said lock sleeve, said compression ring including a band having said symbols thereon;
a securing nut fitting over said compression ring and said lock sleeve to mate with said plug body thereby forcing said compression ring onto said lock sleeve, said securing nut including a slip lock;
rotatable means in frictional contact with said securing nut slip lock whereby the rotation of said member rotates said band of symbols for sequential display of said symbols; and
said indicator means coacts with said band of symbols for designation of selected symbols.

6. The cable identifier system of claim 4 wherein said band of symbols is located on said compression ring.

7. The cable identifier system of claim 4 wherein said band of symbols is located on said rotatable means.
